(19) United States
(12) Patent Application Publication
(10) Pub. No.: US 2002/0017272 A1
(43) Pub. Date: Feb. 14, 2002

(54) Internal combustion engine

(76) Inventors: Achim Guggenmos, Esslingen (DE); Janusz Kwiatkowski, Stuttgart (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 09/909,859

(22) Filed: Jul. 20, 2001

(30) Foreign Application Priority Data
Jul. 20, 2000 (DE) 100 35 239.1

(51) Int. Cl. F02B 3/00; F02B 5/00; F02B 75/02

(52) U.S. Cl. 123/305; 123/302; 123/315; 123/432

(57) ABSTRACT

In an internal combustion engine with direct fuel injection including a cylinder block containing at least one cylinder with a piston, which performs an oscillating motion in the cylinder and a cylinder head including a combustion chamber for the at least one cylinder, a total of five intake and exhaust valves with respective intake and exhaust ducts are arranged in the cylinder head in a circular array and a spark plug and an injector are arranged in a center area of the combustion chamber between the intake and exhaust valves and point towards the center of the combustion chamber.

### BACKGROUND OF THE INVENTION

The invention relates to an internal combustion engine with fuel injection.

DE 197 16 642 C2 discloses a multi-cylinder spark-ignition engine with direct fuel injection which has two intake and two exhaust valves and in which a spark plug is arranged approximately centrally. The injector opens into the combustion chamber in an offset position relative to the axis of the cylinder between one intake valve and the opposite exhaust valve. Similar prior art is also discussed in DE 197 20 490 A1. Internal combustion engines of this kind are generally operated using a so-called jet-guided combustion process, in which the injector distributes the fuel in the direction of the spark plug.

However, the disadvantage of these known internal combustion engines is that, owing to the principle involved, there is only a relatively small area available for the intake and exhaust valves and hence for the inflow and outflow of gases into, and out of, the combustion chamber leading to considerable disadvantages with exhaust and refill thereby limiting the torque and power output of the engine.

It is therefore the object of the present invention to provide an internal combustion engine with direct fuel injection with which a so-called jet-guided combustion process is possible at the same time.

### SUMMARY OF THE INVENTION

In an internal combustion engine with direct fuel injection including a cylinder block containing at least one cylinder with a piston, which performs an oscillating motion in the cylinder and a cylinder head including a combustion chamber for the at least one cylinder, a total of five intake and exhaust valves with respective intake and exhaust ducts are arranged in the cylinder head in a circular array and a spark plug and an injector are arranged in a center area of the combustion chamber between the intake and exhaust valves and point towards the center of the combustion chamber.

The five intake and exhaust valves provided in accordance with the invention can advantageously occupy an area that is so large relative to the total cross-sectional area of the associated cylinder bore that significant advantages are available as regards exhaust and refill compared with known solutions resulting in a significantly increased torque and power output for the internal combustion engine.

Owing to the circular arrangement of the five intake and exhaust valves, there is sufficient space to accommodate the spark plug and the injector in the central area of the combustion chamber. Providing for the required installation space for a central arrangement of the spark plug and the injector with a smaller number of intake and exhaust valves results in a substantially smaller total cross-sectional area for the intake and exhaust valves.

The direct proximity of the spark plug and the injector to one another makes it possible to use a jet-guided combustion process for the operation of the internal combustion engine. This permits the design of the internal combustion engine to be simplified, especially as regards to the geometry of the combustion chamber and the shape of the piston. However, other combustion processes are, of course, also possible for the operation of the internal combustion engine with the structure described.

Overall, this provides for an internal combustion engine with direct fuel injection that represents a very good compromise in terms of a combination of performance and simplicity of construction.

If, in an advantageous embodiment of the invention, the spark plug and the injector are arranged in a position rotated by a certain angle relative to a longitudinal axis of the cylinder head, the accessibility of the spark plug and the injector is improved, on the one hand, and advantages in terms of simplifying the accommodation of the camshaft required to control the intake and exhaust valves are obtained, on the other hand.

Further advantageous embodiments of the invention will become apparent from the following description of the invention on the basis of the accompanying drawings.

### BRIEF DESCRIPTION OF THE DRAWINGS

FIG. 1 is a highly schematic view of an internal combustion engine with a cylinder bore and a piston disposed therein;

FIG. 2 is a plan view of part of the cylinder head of the internal combustion engine according to the invention,

FIG. 3 is a view of the combustion chamber top from the direction of the cylinder bore of the internal combustion engine according to the invention,

FIG. 4 is a top view of a number of combustion chambers of the internal combustion engine according to the invention,

FIG. 5 is a view in the direction of arrow V in FIG. 4, and

FIG. 6 shows a section taken along the line VI-VI in FIG. 1.

### DESCRIPTION OF PREFERRED EMBODIMENTS

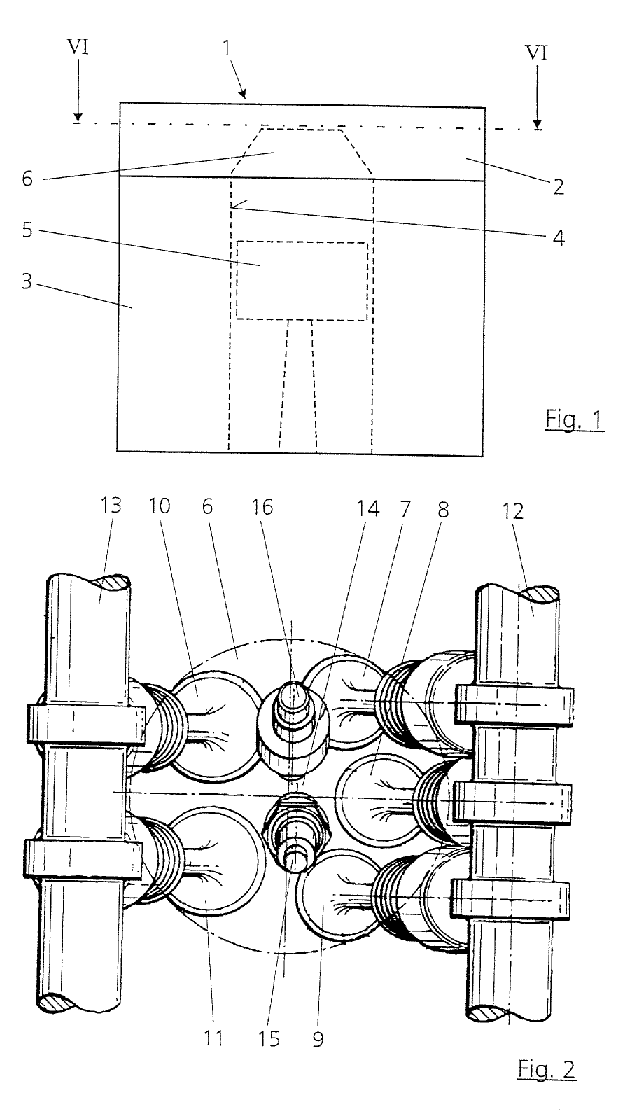

FIG. 1 shows an internal combustion engine 1 with a cylinder head 2 and a cylinder block 3 in a highly schematic representation. The cylinder block 3 has a cylinder bore 4 containing a piston 5, which performs an oscillating motion. The cylinder block 3 under consideration is provided with a plurality of cylinder bores 4, although only one of these is shown. Above the piston 5, the cylinder head 2 includes a combustion chamber.

FIG. 2 shows a total of five intake and exhaust valves 7, 8, 9, 10 and 11 of the internal combustion engine 1, which valves are associated with one of the combustion chambers 6 and are mounted in the cylinder head 2 in a manner that is not illustrated but is known per se. The valves include three intake valves 7, 8, and 9 on one side of the combustion chamber 6 and two exhaust valves 10 and 11 on the other side. The intake valves 7, 8, and 9 are controlled by an intake camshaft 12, whereas the exhaust valves 10, 11 are controlled by an exhaust camshaft 13.

A spark plug 15 and an injector 16 are arranged in a zone 14 situated in the middle of the combustion chamber 6 between the intake valves 7, 8, and 9 on one side and the exhaust valves 10 and 11 on the other side. They are inclined towards the center the combustion chamber 6 so that the spark plug 15 and the injector 16 point towards one another. This spatial proximity of the spark plug 15 to the injector 16 is a very simple means of achieving a so-called jet-guided combustion process during the injection of fuel into the combustion chamber 6.

In a jet-guided combustion process of this kind, the fuel injected by the injector 16 strikes the spark of the spark plug 15 and is thus ignited. Since the jet-guided combustion process is already known per se, it is not described herein in detail. The same applies to the advantages that result from this process. Of course, the described arrangement of the intake and exhaust valves 7, 8, 9, 10 and 11 and the spark plug 15 and injector 16 also allow for combustion methods other than the jet-guided combustion process.

The ratio of the total area of the five intake and exhaust valves 7, 8, 9, 10 and 11 to the area of the cylinder bore 4 is within a range of 0.45-0.7: 1, in particular in a range 0.50-0.65:1. The ratios described enable the internal combustion engine 1 to deliver particularly advantageous figures for engine torque and power output. To calculate the respective areas, use is made, on one hand, of the diameter of the cylinder bore 4 and, on the other hand, of the maximum diameter of the individual intake and exhaust valves 7, 8, 9, 10 and 11, i.e. not the cross section exposed by these valves.

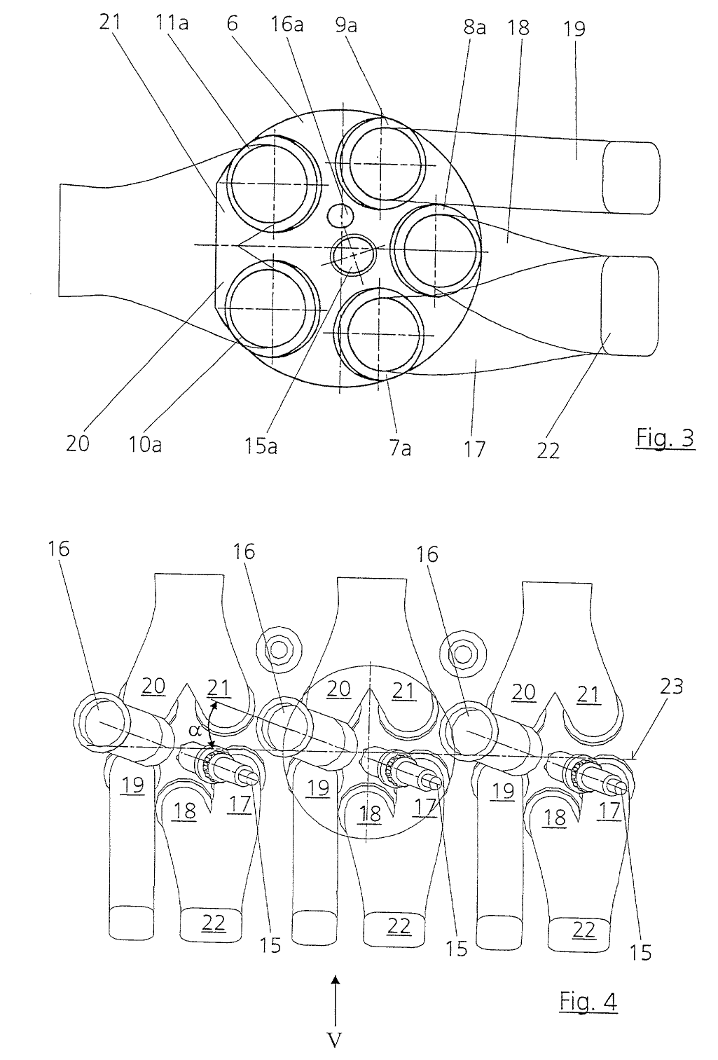

In the illustration shown in FIG. 3, the ratios of the areas of the intake and exhaust valves 7, 8, 9, 10 and 11 to the area of the cylinder bore 4 are again clearly visible. Only the valve seats 7a, 8a, 9a, 10a, and 11a belonging to the intake and exhaust valves 7, 8, 9, 10, and 11 are shown here. Similarly, only the bores 15a and 16a for the spark plug 15 and the injector 16 are shown. It can be seen here that, although the bores 15a and 16a are very close together, neither of the bores 15a and 16a is precisely in the center of the combustion chamber 6.

As can furthermore be seen from FIG. 3, respective intake ducts 17, 18, and 19 are assigned to the intake valves 7, 8, and 9. The same applies also to the exhaust valves 10 and 11, to which exhaust ducts 20 and 21 are assigned. Two of the intake ducts, namely intake ducts 17 and 18, are combined in a zone directly adjoining the associated intake valves 7 and 8 to form a single duct 22. This makes it possible to introduce gas into the combustion chamber 6 through all the intake ducts 17, 18, and 19 by supplying ducts 19 and 22. Intake gas may also be supplied solely through intake duct 19 or through the two intake ducts 17 and 18 together by admitting gas only to duct 22. Each of the three possibilities may be advantageous depending on the flow that is to be established within the combustion chamber 6 that is depending on the particular engine operating condition. Each of the two last-mentioned possibilities produces a swirling flow in the combustion chamber 6.

FIG. 4 once again shows the intake ducts 17, 18 and 19 and exhaust ducts 20 and 21 and the combination of intake ducts 17 and 18 to a single duct 22. It also shows that the spark plug 15 and the injector 16 are arranged offset by an angle α relative to a longitudinal axis 23 of the cylinder head 2, α being about 15-20° in the present case. On one hand, this means that the spark plugs 15 and the injectors 16 can be installed and removed more easily as access to one is not obstructed by the other. On the other hand, the angle α is chosen in such a way that space is provided for the two camshafts 12 and 13 (not illustrated in this figure). The angle α is the same as the angle formed in FIG. 3 between the longitudinal axis 23 and the connecting line between the bores 15a and 16a for the spark plug 15 and the injector 16.

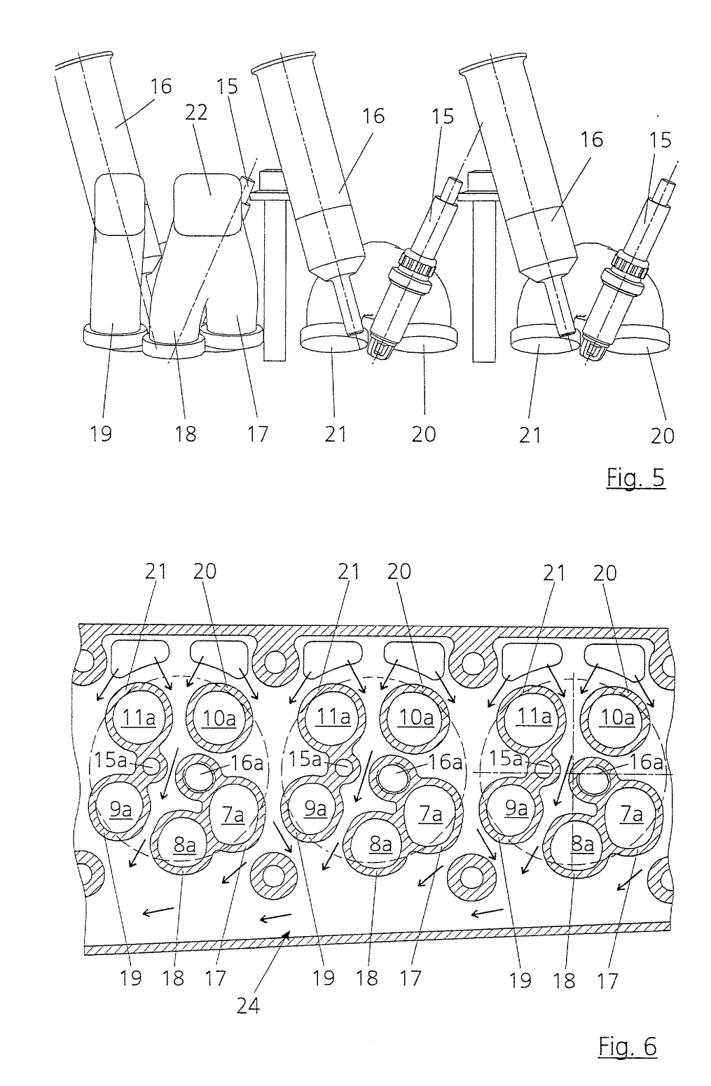

FIG. 5 is a view intended to illustrate the relative positions of the spark plug 15 and the injector 16 and shows clearly how these two elements point towards one another, for which purpose they are arranged obliquely relative to the longitudinal axis of the cylinder.

The section through the cylinder head 2 shown in FIG. 6 illustrates a cooling system 24, the coolant of which flows essentially perpendicularly to the longitudinal axis 23 of the cylinder head 2, as indicated by the arrows. Despite the relatively large number of five intake and exhaust valves 7, 8, 9, 10 and 11, it is possible with the design of the present invention to pass coolant between the valves and also between the spark plug 15 and the injector 16, allowing very effective cooling of the combustion chamber 6.

To enable the cross-flow through the cylinder head between the intake and exhaust valves 17-21, as indicated by the arrows, and furthermore to ensure that the cylinder head is of rigid construction, the spark plug well 15a is joined to, or cast onto, the walls of the exhaust ducts 11, 21, and the injector well 16a is joined to or cast onto the walls of at least one intake/exhaust ducts 17, 18 or 20.

These two elements point toward one another and they are arranged at an oblique angle relative to the longitudinal axis of the cylinder.

What is claimed is:

1. An internal combustion engine with direct fuel injection comprising: an engine block containing at least one cylinder bore, a piston, which performs an oscillating motion, disposed in said at least one cylinder bore, a cylinder head at least partially containing a combustion chamber and covering said at least one cylinder bore, a total of five intake and exhaust valves in connection with respective intake and exhaust ducts arranged in said cylinder head, and a spark plug and an injector mounted on said cylinder head in a central area of the combustion chamber between said intake and exhaust valves and pointing towards said combustion chamber.

2. An internal combustion engine according to claim 1, wherein said spark plug and said injector are arranged in a position rotated by a certain angle (a) relative to a longitudinal axis of said cylinder head.

3. An internal combustion engine according to claim 1, wherein said spark plug and said injector are disposed at an angle so as to point towards one another.

4. An internal combustion engine according to claim 1, wherein the ratio of the total area of the intake and exhaust valves to the area of the cylinder bore is within a range of 0.45:1 to 0.7:1.

5. An internal combustion engine according to claim 4, wherein the ratio of the total area of the intake and exhaust valves to the area of the cylinder bore is within a range of 0.50:1 to 0.65:1.

6. An internal combustion engine according to claim 1, wherein three intake valves with three associated intake ducts and two exhaust valves with two associated exhaust ducts are provided.

7. An internal combustion engine according to claim 6, wherein two of the intake ducts are combined in the immediate vicinity of the associated intake valves to form a common duct.

8. An internal combustion engine according to claim 1, wherein the cylinder head has a cooling system directing the coolant to flow essentially perpendicularly to the longitudinal axis of the cylinder head.

9. An internal combustion engine with direct fuel injection having the following features: a cylinder block containing at least one cylinder, a piston, which performs an oscillating motion in said at least one cylinder, a cylinder head covering said at least one cylinder, said cylinder head at least partially containing a combustion chamber, a total of five intake and exhaust valves in communication with respective intake and exhaust ducts arranged in said cylinder head, and a spark plug and an injector mounted on said cylinder head in a central area of the combustion chamber between said intake and exhaust valves and pointing towards said combustion chamber, said spark plug and the injector being arranged in a position rotated by a certain angle (α) relative to a longitudinal axis of the cylinder head.

10. An internal combustion engine with direct fuel injection, comprising: an engine block containing at least one cylinder, at least one piston, which performs an oscillating motion in said at least one cylinder, a cylinder head at least partially containing a combustion chamber and covering said at least one cylinder, a total of five intake and exhaust valves in communication with respective intake and exhaust ducts arranged in said cylinder head, and a spark plug and an injector mounted on said cylinder head in a central area of the combustion chamber between the intake and exhaust valves and pointing toward said combustion chamber, the ratio of the total area of the intake and exhaust valves to the area of the cylinder bore being within a range of 0.45:1 to 0.7:1.

11. An internal combustion engine according to claim 6, wherein said intake and exhaust valves are arranged in a circle with said spark plug and said injector being arranged in the center area of said circle.

12. An internal combustion engine according to claim 6, wherein the exhaust valves are larger in diameter than the intake valves.
